(19) United States
(12) Patent Application Publication
(10) Pub. No.: US 2021/0003475 A1
(43) Pub. Date: Jan. 7, 2021

(54) TEST SYSTEM FOR REPEATEDLY OPERATING OPENING/CLOSING OF BLIND

(71) Applicant: FITI TESTING & RESEARCH INSTITUTE, Seoul (KR)

(72) Inventors: Dong Hwan Kim, Seoul (KR); Gi Yeong Lee, Gyeonggi-do (KR); Jeong Taek Oh, Seoul (KR); Jeong Hyeon Lee, Gyeonggi-do (KR)

(21) Appl. No.: 16/980,748

(22) PCT Filed: Jan. 11, 2019
(86) PCT No.: PCT/KR2019/000469

§ 371 Date: Sep. 14, 2020

(30) Foreign Application Priority Data
Mar. 15, 2018 (KR) 10-2018-0030426

(51) Int. Cl. G01M 13/022; E06B 9/42; E06B 9/70; F16G 13/07; F16G 1/22

(52) U.S. Cl. CPC G01M 13/022; E06B 9/42; E06B 2009/6809; F16G 13/07; F16G 1/22; E06B 9/70

(57) ABSTRACT

A test system for repeatedly operating the opening/closing of a blind is disclosed. The test system for repeatedly operating the opening/closing of a blind, of the present invention, comprises: an operating device for operating a cord so as to repeatedly adjust the height of a blind; and a control device for controlling the operation of the operating device, wherein the height of the blind is repeatedly adjusted when the movement distance of the cord and a repeated adjustment cycle for the height of the blind are inputted in the control device. According to the present invention, provided is the test system for repeatedly operating the opening/closing of the blind, the system repeatedly simulating the opening/closing motions of the blind so as to evaluate the durability of a clutch and the cord.

### TECHNICAL FIELD

The present disclosure relates to a test system for repeatedly operating the opening/closing of a blind and, more particularly, to a window blind repeated operation test system characterized in that raising and lowering operations of a window blind are repeatedly performed, such that durability of a clutch and a cord of the window blind can be evaluated.

### BACKGROUND ART

Window blinds are a type of window shade. Window blinds are generally operated by adjusting a cord, which cyclically rotates in both directions, to raise and lower a roll screen or slats.

The cord may be connected to a circular toothed gear within a clutch. When a user pulls the cord in a downward direction, the circular toothed gear may rotate, and the roll screen or the slats may be operated. Since the force of the user applied to operate the window blind may be concentrated on the cord and the clutch, breakdown of the window blind may be mostly caused by damage to the cord or the clutch.

In this regard, Korean Patent Publication Registration No. 1121668 (hereinafter referred to as “related art 1”) discloses a rack for testing a roller blind. In related art 1, short square frames including vertical rail grooves formed on side surfaces thereof may be installed in an installation frame on a wall, a clamp for fixing and releasing a roller blind to be tested may be installed on a side surface portion of the short square frame, the clamp may be configured to be caught by an engaging protrusion and fastened and fixed as a fastening piece made by screw-coupling a fixed shaft bolt and a hinge shaft bolt is inserted into an upper vertical rail groove of the short square frame, and a fixed lever piece having an engaging portion and an operation lever piece which is elastically operated may be pivotally connected to lower portions of the fixed shaft bolt and the hinge shaft bolt.

Before shipping finished products, an examiner may examine durability of the roller blinds and check the operation state of the cord with the roller blinds hung on the rack. Specifically, the examiner may check whether the roll screen becomes tilted while being raised and lowered using the cord, whether the roll screen becomes warped when the roll screen is rolled up, etc.

However, as in related art 1, conventional window blind operation tests are limited to simply sorting defective products from finished products, and thus may have a limitation in that a defect in the cord or the clutch might only be found when a user actually uses the window blind.

### DISCLOSURE OF INVENTION

### Technical Problem

An aspect of the present disclosure is directed to providing a test system for repeatedly operating the opening/closing of a blind (hereinafter referred to as “a window blind repeated operation test system”) configured to enable evaluation of the durability of a clutch and a cord of a window blind by repeatedly performing raising and lowering operations of the window blind.

### Solution to Problem

According to the present disclosure, the window blind repeated operation test system may include an operating device configured to manipulate the cord such that raising and lowering operations of the window blind are repeatedly performed; and a controlling device configured to control operation of the operating device, wherein when a user inputs, to the controlling device, a movement distance of the cord and a repeating cycle of the raising and lowering operations of the window blind, the raising and lowering operations of the window blind may be repeatedly performed.

A plurality of beads may be coupled to the cord, and the operating device may include: a gear having teeth thereon between which the plurality of beads are inserted; a motor configured to rotate the gear; and a controller configured to receive a signal of the controlling device and control rotation of the motor in both directions.

An insertion groove into which the cord is inserted may be formed in each of the teeth of the gear.

A plurality of beads may be coupled to the cord, and the operating device may include: a controller configured to receive a signal of the controlling device; a motor configured to rotate in both directions by control of the controller; and a chain transmission unit driven by the motor, wherein a protruding portion configured to push the plurality of beads may be installed in a chain in the chain transmission unit.

The chain transmission unit may include a pair of sprockets which are rotated by the motor and on which the chain is placed. The chain may include transmission links in which a tooth of the pair of sprockets is caught between two rollers; and connection links configured to connect the transmission links, each connection link including a spring mounted therein to press the protruding portion towards the plurality of beads. A guide rail configured to guide the plurality of beads in a direction in which the chain moves may be formed on the opposite side to the chain with respect to the cord.

### Advantageous Effects of Invention

According to the present disclosure, the window blind repeated operation test system is characterized in that when the user inputs, to the controlling device, the movement distance of the cord and the repeating cycle of the raising and lowering operations of the window blind, the window blind may be repeatedly raised and lowered. By doing so, the raising and lowering operations of the window blind may be repeatedly performed, such that the durability of the clutch and the cord of the window blind can be evaluated.

### BRIEF DESCRIPTION OF DRAWINGS

The foregoing and other objects, features, and advantages of the invention, as well as the following detailed description of the embodiments, will be better understood when read in conjunction with the accompanying drawings. For the purpose of illustrating the invention, there is shown in the drawings an exemplary embodiment that is presently preferred, it being understood, however, that the invention is not intended to be limited to the details shown because various modifications and structural changes may be made therein without departing from the spirit of the invention and within the scope and range of equivalents of the claims. The use of the same reference numerals or symbols in different drawings indicates similar or identical items.

FIG. 1 is a perspective view of a window blind repeated operation test system according to one embodiment of the present disclosure.

FIG. 2 is a partial exploded view of a gear of the window blind repeated operation test system of FIG. 1. FIG. 2(b) is a cross-sectional view taken along the line A-A′ of FIG. 2(a).

FIGS. 3 and 4 are partial exploded views of a chain transmission unit of a window blind repeated operation test system according to another embodiment of the present disclosure. FIG. 3(b) is an exploded view of some components illustrated in FIG. 3(a).

### DESCRIPTION OF EMBODIMENTS

Hereinafter, preferable exemplary embodiments of the present disclosure will be described in detail referring to the attached drawings. In the following description, known functions or features will be omitted in order to clarify the gist of the present disclosure.

A window blind repeated operation test system of the present disclosure may be configured to perform durability tests for a clutch and a cord of a window blind by repeatedly performing raising and lowering operations of the window blind.

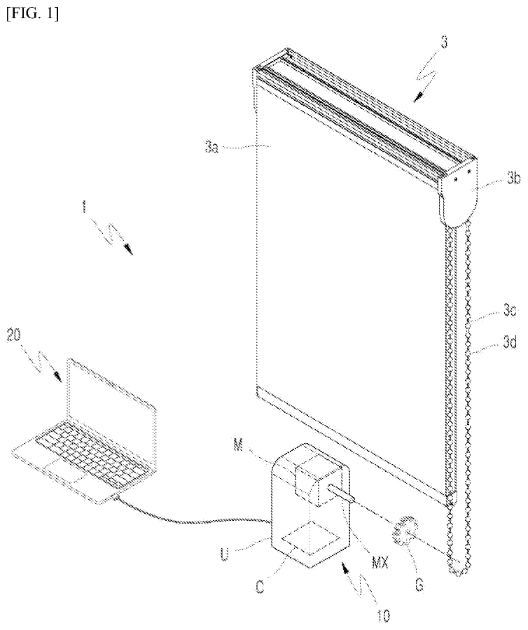

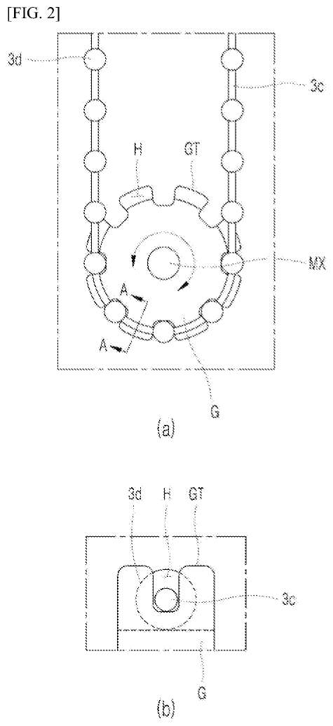

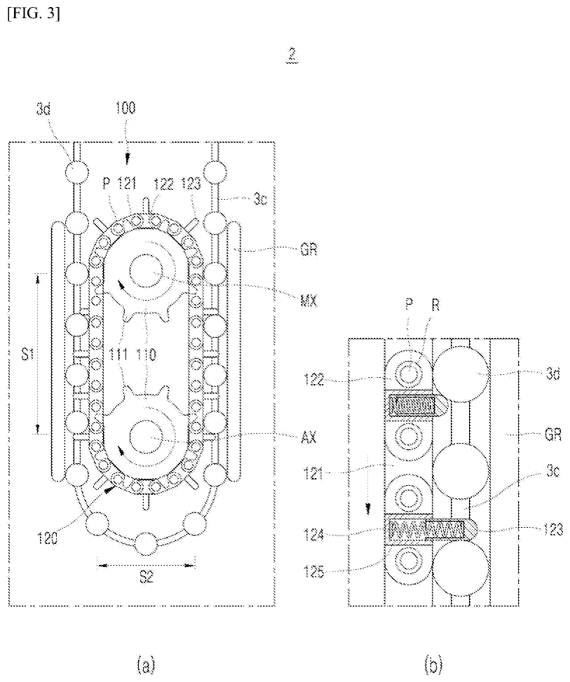

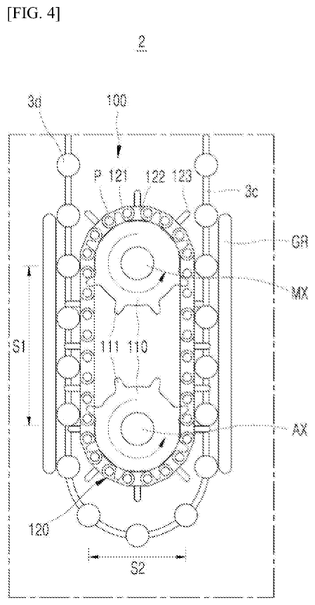

FIG. 1 is a perspective view of a window blind repeated operation test system according to one embodiment of the present disclosure. FIG. 2 is a partial exploded view of a gear of the window blind repeated operation test system of FIG. 1. FIGS. 3 and 4 are partial exploded views of a chain transmission unit of a window blind repeated operation test system according to another embodiment of the present disclosure.

As illustrated in FIG. 1, a window blind repeated operation test system 1 of the present disclosure may be used for a repeated operation test of a window blind 3 which is configured to be raised and lowered when a user pulls a cord 3c at either side thereof.

The window blind repeated operation test system 1 according to an embodiment of the present disclosure may be configured to perform durability tests for a clutch 3b and a cord 3c by repeatedly performing the raising and lowering operations of the window blind 3, and may include an operating device 10 and a controlling device 20.

As illustrated in FIGS. 1 and 2, the operating device 10 may be a component configured to manipulate the cord 3c such that the window blind 3 is repeatedly raised and lowered, and may include a gear G, a motor M, and a controller C.

The motor M and the controller C may be installed within a housing U. A rotational shaft MX of the motor M may protrude outwards from the housing U, and the gear G may be coupled to the rotational shaft MX of the motor M.

A plurality of beads 3d may be coupled to the cord 3c. If the plurality of beads 3d are not provided in the cord 3c of the window blind 3, which is a test subject, testing beads (not illustrated) may be temporarily coupled to the cord 3c, instead of the plurality of beads 3d. Referring to Japanese Utility Model Publication No. 3051112, each of testing beads may have a hemisphere shape, and a pair of the hemisphere-shaped testing beads may be coupled to each other with a cord placed therebetween, such that a bonding force is generated between the pair of the hemisphere-shaped testing beads and the cord.

As illustrated in FIG. 2(a), the gear G may be a component configured to transfer rotational force of the motor M to the cord 3c, and may be placed on the cord 3c at a lower end portion thereof. Accordingly, the cord 3c may surround a lower portion of the gear G, and the plurality of beads 3d may be inserted between teeth of the gear G (hereinafter referred to as “gear teeth GT”).

As illustrated in FIG. 2, an insertion groove H may be formed in each of the gear teeth GT such that the cord 3c is inserted into the insertion groove H. Accordingly, even when the beads 3d are deeply inserted between the gear teeth GT, the gear teeth GT may be prevented from interfering with the cord 3c.

The motor M may be a component configured to rotate the gear G, and may be provided as a step motor. The step motor is a motor that rotates at a predetermined angle, and the rotation angle and the rotation speed of the step motor may be precisely controlled by the controller C.

In the step motor, the rotation angle may be proportional to the number of inputted pulse signals, and the rotation speed may be proportional to the frequency of the inputted pulse signals. Since the step motor is a well-known technology, detailed description thereof will be omitted.

The controller C may be a component configured to receive a signal of the controlling device 20 and control rotation of the motor M in both directions, and may be provided as a step motor driver module. Since the step motor driver module is a well-known technology, detailed description thereof will be omitted.

As illustrated in FIG. 1, the controlling device 20 may be a component configured to control operation of the operating device 10, and may be provided as an input-output device configured to transmit and receive a signal to and from the controller C.

Software configured to transmit and receive a signal to and from the step motor driver module may be installed in the controlling device 20. A window blind repeated operation test may be started as the user inputs, to an input/output window displayed on a screen of the input-output device, a movement distance of the cord 3c, a repeating cycle of the raising and lowering operations of the window blind 3, a total test time, etc.

For example, the user may input, to the input/output window, “1 [m]” for the movement distance of the cord 3c, “10 [sec]” for the repeating cycle of the raising and lowering operations of the window blind 3, and “10 [hr]” for the total test time.

Then, the controlling device 20 may transmit, to the controller C, a signal corresponding to the input, and the controller C may control operation of the motor M to correspond to the received signal, such that one operation cycle in which the window blind 3 is raised and lowered for 10 seconds is repeated for 10 hours, for a total of 3600 operation cycles.

When the window blind repeated operation test is completed, the user may disassemble the clutch 3b of the window blind 3, check for occurrence of abrasion and damage in the clutch 3b and the cord 3c, and evaluate the durability of the clutch 3b and the cord 3c. “3a,” which is not described, is a roll screen.

As illustrated in FIGS. 3 and 4, in a window blind repeated operation test system 2 according to another embodiment of the present disclosure, an operating device 10 may include a chain transmission unit 100, a motor M, and a controller C. Hereinafter, for easy understanding of the another embodiment of the present disclosure, description of the same components as those of the previously described embodiment of the present disclosure will be omitted.

The chain transmission unit 100 may be a component configured to transfer rotational force of the motor M to the cord 3c, and may include a sprocket 110, a chain 120, and a guide rail GR.

The sprocket 110 may be a component configured to continuously move the chain 120, and may be provided as a pair of sprockets 110. Any one of the pair of sprockets 110 may be coupled to a rotational shaft MX of the motor M, and the other of the pair of sprockets 110 may be coupled to an auxiliary shaft AX, such that the pair of sprockets 110 are rotated by a chain drive. The auxiliary shaft AX should be understood as a shaft that is rotatably installed in a housing.

As illustrated in FIGS. 3 and 4, the pair of sprockets 110 may be produced in the same shape, and may be vertically disposed to be surrounded by the cord 3c. A chain 120 may be placed on the pair of sprockets 110.

The chain 120 may form a vertically moving section (hereinafter referred to as “vertical section 1”) between the pair of sprockets 110. The vertical section S1 may be formed between the pair of sprockets 110 and a left-side portion of the cord 3c and between the pair of sprockets 110 and a right-side portion of the cord 3c. Hereinafter, a movement section in which the chain 120 moves while engaging the pair of sprockets 110 will be referred to as “curved section S2.”

As illustrated in FIG. 3, the chain 120 may include transmission links 121, connection links 122, protruding portions 123, springs 124, and guides 125. The transmission links 121 and the connection links 122 may be alternately connected to each other. The transmission links 121 and the connection links 122 may be connected by a pin P such that the transmission links 121 and the connection links 122 rotate relative to each other. A roller R may be rotatably coupled to each pin P.

The sprocket 110 may include teeth formed thereon (hereinafter referred to as “wheel teeth 111”), and each of the wheel teeth 111 may be caught between two rollers R (i.e., between two pins P) in a transmission link 121. The wheel teeth 111 may not be caught between two rollers R in a connection link 122.

Each one of the protruding portions 123, the springs 124, and the guides 125 may be formed between two rollers R (i.e., between two pins P) in a connection link 122. The guides 125 may be a component configured to guide sliding movement of the protruding portions 123, and may be formed in the connection links 122.

The springs 124 may be a component configured to press the protruding portions 123 towards beads 3d, and may be inserted into the guides 125. End portions of a spring 124 may be coupled to a guide 125 and a protruding portion 123. Even when the spring 124 is elastically recovered to a maximum extent, the protruding portion 123 may not be completely released from the guide 125.

As illustrated in FIGS. 3 and 4, the protruding portions 123 may be a component configured to push the beads 3d in an operating direction of the cord 3c, and may be pressed towards the beads 3d by the springs 124 while being inserted into the guides 125. The operating direction of the cord 3c means a direction in which the user pulls the cord 3c, i.e., a downward direction in FIGS. 3 and 4.

When there is no interference from the beads 3d (hereinafter referred to as “non-interference state”), the protruding portions 123 may protrude to the extent that the protruding portions 123 can push the beads 3d in the operating direction of the cord 3c as the springs 124 are elastically recovered. That is, the protruding portions 123 may protrude farther than a center of each bead 3d (see a lower protruding portion 123 in FIG. 3(b)). Although not specifically illustrated, the protruding portions 123 may protrude towards the bead 3d at a position where the protruding portions 123 do not contact the cord 3c (that is, right next to the cord 3c).

On the contrary, when there is interference from the beads 3d (hereinafter referred to as “interference state”), the protruding portions 123 may protrude to the extent that the protruding portions 123 cannot push the beads 3d in the operating direction of the cord 3c due to the interference from the beads 3d. That is, the protruding portions 123 may not protrude farther than the center of each bead 3d (see the lower protruding portion 123 in FIG. 3(b)).

Protruding portions 123 that are passing the curved section S2 in FIG. 3(a) are in the non-interference state. On the contrary, protruding portions 123 that are passing the vertical section S1 in FIG. 3(a) are in the non-interference state or the interference state depending on whether there is interference from the beads 3d.

As illustrated in FIG. 3(b), any one or more of the protruding portions 123 that are passing the vertical section S1 while in the non-interference state may certainly push the beads 3d in the operating direction of the cord 3c (by contacting the beads 3d as the chain 120 moves).

FIG. 3(a) illustrates a state in which the cord 3c that is positioned on the right side of the pair of sprockets 110 is pulled in the downward direction by the protruding portions 123 that are pushing the beads 3d, and FIG. 4 illustrates a state in which the cord 3c that is positioned on the left side of the pair of sprockets 110 is pulled in the downward direction by the protruding portions 123 that are pushing the beads 3d.

The beads 3d formed in the cord 3c of the window blind 3 are not limited to a specific size, and may have various sizes and gaps therebetween depending on the manufacturer and model.

The window blind repeated operation test system 2 according to the another embodiment of the present disclosure has an advantage in that as any one or more of the protruding portions 123 that are passing the vertical section S1 while in the non-interference state may certainly push the beads 3d in the operating direction of the cord 3c, the window blind repeated operation test may be performed regardless of the size and gap of the beads 3d, i.e., regardless of the manufacturer or model of the window blind 3.

As illustrated in FIGS. 3 and 4, a guide rail GR configured to guide the beads 3d in a direction in which the chain 120 moves may be formed on the opposite side to the chain 120 with respect to the cord 3c. The guide rail GR may be mounted in a housing U (such that the position of the guide rail GR can be adjusted in a horizontal direction depending on the size of the beads 3d).

The guide rail GR may prevent the beads 3d from moving away from the chain 120 in the horizontal direction. Accordingly, a state in which the protruding portions 123 push the beads 3d in the operating direction of the cord 3c may be stably maintained.

According to the present disclosure, the window blind repeated operation test system is characterized in that when the user inputs, to the controlling device, the movement distance of the cord and the repeating cycle of the raising and lowering operations of the window blind, the window blind may be repeatedly raised and lowered. By doing so, the raising and lowering operations of the window blind may be repeatedly performed, such that the durability of the clutch and the cord of the window blind can be evaluated.

While specific exemplary embodiments of the present disclosure are described and illustrated above, it would be obvious to those skilled in the art that various modifications and variations thereto can be made within the spirit and scope of the present disclosure. Accordingly, such modifications or variations are not to be regarded as a departure from the spirit or scope of the present disclosure, and it is intended that the present disclosure cover the modifications and variations of the present disclosure provided they come within the scope of the appended claims and their equivalents.

### INDUSTRIAL APPLICABILITY

The window blind repeated operation test system according to the present disclosure may enable evaluation of the durability of the clutch and the cord of the window blind by repeatedly performing the raising and lowering operations of the window blind. In this regard, the window blind repeated operation test system of the present disclosure overcomes the limits of existing technology, and there is thus sufficient possibility not only of the use of the related technology but also of the actual sale of apparatuses to which the related technology is applied. In addition, the present disclosure can be obviously and practically implemented by those skilled in the art. Therefore, the present disclosure is industrially applicable.

REFERENCE SIGNS LIST

1 and 2: WINDOW BLIND REPEATED OPERATION TEST SYSTEM

| | |
|---|---|
| 10: OPERATING DEVICE | 100: CHAIN TRANSMISSION UNIT |
| G: GEAR | 110: SPROCKET |
| GT: GEAR TOOTH | 111: WHEEL TOOTH |
| H: INSERTION GROOVE | 120: CHAIN |
| M: MOTOR | 121: TRANSMISSION LINK |
| MX: ROTATION SHAFT | P: PIN |
| C: CONTROLLER | R: ROLLER |
| U: HOUSING | 122: CONNECTION LINK |
| AX: AUXILIARY SHAFT | 123: PROTRUDING PORTION |
| 3: WINDOW BLIND | 124: SPRING |
| 3a: ROLL SCREEN | 125: GUIDE |
| 3b: CLUTCH | S1: VERTICAL SECTION |
| 3c: CORD | S2: CURVED SECTION |
| 3d: BEAD | GR: GUIDE RAIL |

20: CONTROLLING DEVICE

1. A window blind repeated operation test system comprising:
an operating device configured to manipulate a cord such that a window blind is repeatedly lowered and raised; and
a controlling device configured to control operation of the operating device,
wherein when a movement distance of the cord and a repeating cycle of raising and lowering operations of the window blind are inputted into the controlling device, the window blind is repeatedly lowered and raised.

2. The window blind repeated operation test system of claim 1, wherein a plurality of beads are coupled to the cord, and
the operating device comprises:
a gear having teeth thereon between which the plurality of beads are inserted;
a motor configured to rotate the gear; and
a controller configured to receive a signal of the controlling device and control rotation of the motor in both directions.

3. The window blind repeated operation test system of claim 2, wherein an insertion groove into which the cord is inserted is formed in each of the teeth of the gear.

4. The window blind repeated operation test system of claim 1, wherein a plurality of beads are coupled to the cord, and
the operating device comprises:
a controller configured to receive a signal of the controlling device;
a motor configured to rotate in both directions by control of the controller; and
a chain transmission unit driven by the motor,
wherein the plurality of beads are pushed by protruding portions installed in a chain in the chain transmission unit.

5. The window blind repeated operation test system of claim 4, wherein the chain transmission unit comprises a pair of sprockets which are rotated by the motor and on which the chain is placed, and
the chain comprises:
transmission links in which teeth of the pair of sprockets are caught between rollers; and
connection links configured to connect the transmission links, each of the connection links including a spring and a protruding portion, wherein the spring is configured to press the protruding portion towards the plurality of beads,
wherein a guide rail configured to guide the plurality of beads in a direction in which the chain moves is formed on the opposite side to the chain with respect to the cord.
